(19) United States
(12) Patent Application Publication
(10) Pub. No.: US 2006/0068757 A1
(43) Pub. Date: Mar. 30, 2006

(54) Method, apparatus and system for maintaining a persistent wireless network connection

(76) Inventors: Sukumar Thirunarayanan, San Marcos, CA (US); Marc Meylemans, San Diego, CA (US)

Correspondence Address: INTEL CORPORATION, P.O. BOX 5326, SANTA CLARA, CA, 95056-5326, US

(21) Appl. No.: 10/956,980

(22) Filed: Sep. 30, 2004

(51) Int. Cl. H04M 3/16

(52) U.S. Cl. 455/411; 455/410

(57) ABSTRACT

A method, apparatus and system to enable remote computing devices to maintain secure persistent wireless network connections. In one embodiment, a monitoring component may determine whether a user is logged into the network. If the user is not logged into the network, the monitoring module may retrieve and apply a persistent profile to the device. If the persistent profile is associated with a machine certificate, the machine certificate may be used to authenticate the device to the network, thus enabling the device to be securely connected to the wireless network even if the user is not logged in.

### BACKGROUND

Computing devices connected via wired networks typically maintain a persistent connection to the network via a physical connector (e.g., an Ethernet cable). This physical connection ensures that the device is capable of maintaining a network connection even when the user is not logged on to the device. This persistent connection may provide various benefits. For example, in a corporate environment, the fact that computing devices on wired networks may maintain a persistent network connection enables information technology (“IT”) administrators to access the device, regardless of whether the user is logged on. This ability may prove useful and/or helpful if the IT administrator has to “push” a patch to a device when the user is not logged on or physically present.

In case of wireless networks, however, a computing device is currently incapable of maintaining a secure persistent wireless network connection unless a user is logged on to the device. Under certain circumstances, when a user is logged out of the device, the device may be connected to the wireless network via a “persistent profile”, but this connection typically comprises an unsecure connection. Profiles are well known to those of ordinary skill in the art and typically include saved settings and other such customized information for different computing environments and/or users. A persistent profile refers to a profile created for situations when the user may not be logged on to the device.

In summary, currently, unless a wireless device is in the vicinity of a Wireless Access Point (“WAP”) and has a user logged on to the device; the device is unable to maintain a secure connection to the wireless network. Without a secure connection, IT administrators are unable to securely access the device to push patches or perform any other administrative tasks that typically require a secure connection.

### BRIEF DESCRIPTION OF THE DRAWINGS

The present invention is illustrated by way of example and not limitation in the figures of the accompanying drawings in which like references indicate similar elements, and in which:

FIG. 1 illustrates a device on a typical wireless network;

FIG. 2 illustrates an embodiment of the present invention; and

FIG. 3 is a flowchart illustrating how a typical wireless device may function currently as well as according to an embodiment of the present invention.

### DETAILED DESCRIPTION

Embodiments of the present invention provide a method, apparatus and system for maintaining a secure persistent wireless connection. More specifically, embodiments of the present invention utilize machine-based certificates to maintain secure persistent wireless network connections when a user is not logged on to the device. As used herein, the term “when a user is not logged on” shall include the situation where a computing device has just booted up and a user has not yet logged on, as well as the situation where a user has just logged off the device. Any reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

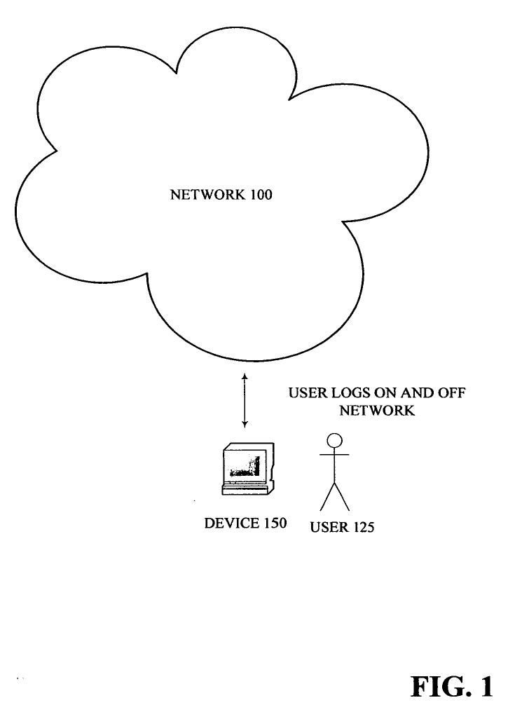

As previously described, a wireless computing device is not typically capable of maintaining a secure persistent wireless network connection unless a user is logged on. At best, the device may establish an unsecure connection to the wireless network via the use of persistent profiles. As utilized herein, a “secure” connection includes a certificate-based connection, while an “unsecure” connection may refer to a connection without any security and/or a connection with a lower level of security (e.g., username/password) than certificate-based connections. Certificate-based security is well known to those of ordinary skill in the art and is described further below. As illustrated in FIG. 1, when the device “(Wireless Device 150”) is in the vicinity of a wireless network (“Network 100”), the device user (“User 125”) may log into the network. User 125 may have a user certificate associated with him or her while Wireless Device 150 may have a machine certificate associated with it. Typically, when User 125 logs onto Wireless Device 150 and Wireless Device 150 is recognized by Network 100, Network 100 may utilize the user certificate to authenticate the user. If necessary, Network 100 may also utilize the machine certificate to authenticate Wireless Device 150. The use of user certificates and machine certificates to authenticate users and devices on networks is well known to those of ordinary skill in the art and further description thereof is omitted herein in order not to unnecessarily obscure embodiments of the present invention. The user and/or device will continue to be securely connected to Network 100 while the user is logged onto Wireless Device 150. Thereafter, when the user logs out of Network 100, Wireless Device 150 loses its secure connection to Network 100. If configured to do so, Wireless Device 150 may then apply a persistent profile to establish an unsecure connection to Network 100. Alternatively, if not so configured, Wireless Device 150 may not be able to establish any connection at all to Network 100.

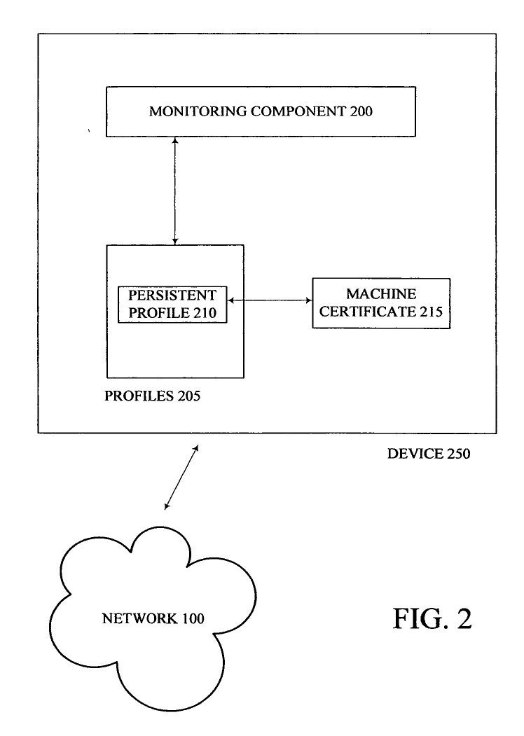

According to an embodiment of the present invention, a wireless device may be securely connected to a wireless network even if the user is not logged onto the device and/or recognized by the network (hereafter referred to collectively as “logged on to the system”). Embodiments of the present invention utilize the previously described machine certificates associated with the device to provide the necessary level of security for the device, to enable the device to establish and maintain a secure connection to the wireless network when the user is not logged on to the system. As illustrated conceptually in FIG. 2, Wireless Device 250 may include Monitoring Component 200, comprising hardware, software, firmware and/or any combination thereof. In one embodiment, Monitoring Component 200 may receive notification (e.g., from the operating system, via an operating system event) that User 125 is logged off from the system. When Monitoring Component 200 determines that Wireless Device 250 is not connected to Network 100 (e.g., User 125 is not logged on to the system), Monitoring Component 200 may examine the various profiles on Wireless. Device 250 (collectively “Profiles 205”). Profiles 205 may comprise all the profiles on Wireless Device 250, including one or more persistent profiles for use when the user is not logged on to the device. More specifically, Monitoring Component 200 may examine the various profiles on Wireless Device 250, identify the persistent profiles available on Wireless Device 250, and then select and apply a persistent profile based on criteria that matches the current Network 100.

According to one embodiment of the present invention at least one of the persistent profiles on Wireless Device 250 may be associated with a machine certificate (illustrated in FIG. 2 as “Persistent Profile 210” associated with “Machine Certificate 215”). By associating the machine certificate with a profile, an embodiment of the present invention enables Wireless Device 250 to securely connect to Network 100 when a user is not logged on to the system. Thus, in the scenario above when Monitoring Component 200 determines that User 125 is not logged onto the system, Monitoring Component 200 may select and apply one of the persistent profiles in Profiles 205 to Wireless Device 250. In one embodiment, Monitoring Component 200 may then examine the applied persistent profile to determine whether it has a machine certificate associated with it. As previously described, Persistent Profile 210 is an example of a persistent profile with Machine Certificate 215 associated with it. Thus, upon selecting and applying Persistent Profile 210, Monitoring Component 200 may then examine the profile to determine whether a machine certificate is associated with it. Upon discovering that Persistent Profile 210 is associated with Machine Certificate 215, Monitoring Component 200 locates and utilizes Machine Certificate 215 to authenticate Wireless Device 250 on Network 100. This authentication enables Wireless Device 250 to establish a secure connection to the network. When User 125 logs into the system, Monitoring Component 250 may recognize the event and disable Persistent Profile 210, thus enabling Wireless Device 250 to establish a secure connection to Wireless Network 100 via traditional methods (e.g., authenticating User 125).

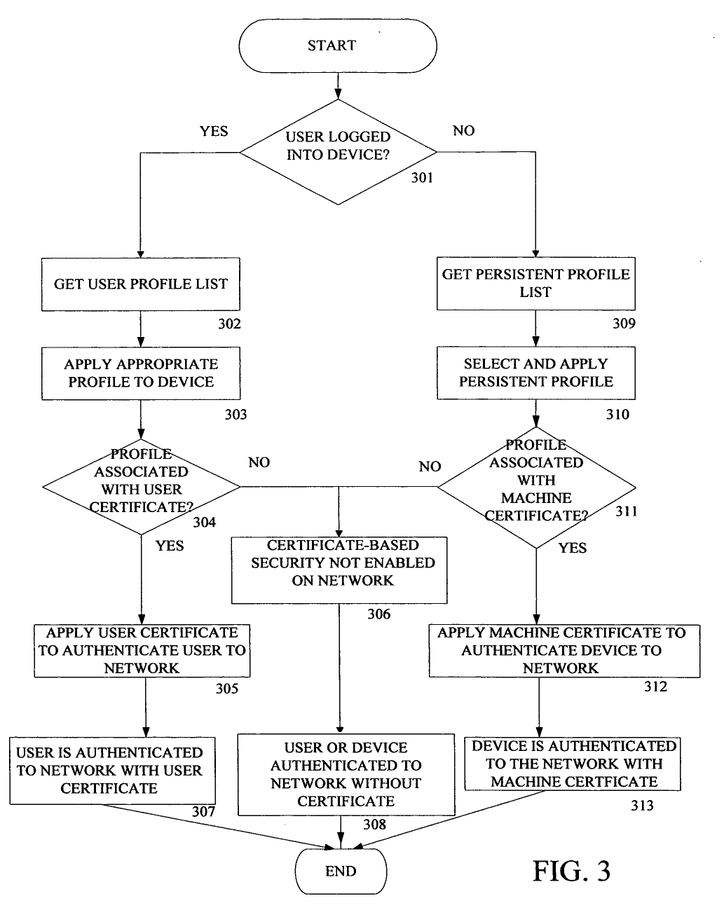

FIG. 3 is a flow chart illustrating how a typical wireless device may function currently as well as according to an embodiment of the present invention. Although the following operations may be described as a sequential process, many of the operations may in fact be performed in parallel and/or concurrently. In addition, the order of the operations may be re-arranged without departing from the spirit of embodiments of the invention. Operations 301-307 describe a scenario by which a wireless device may currently connect to and be authenticated by a wireless network. In 301, the monitoring component may determine whether a user is logged onto the system. If the user is logged on, then in 302, the user's profile list may be retrieved and in 303, one of the profiles may be selected and applied. In 304, the monitoring component may examine the applied profile to determine whether the profile has an associated user certificate. If it does, then in 305, the user certificate may be used to authenticate the user on the network and thereafter, the user may be authenticated to the wireless network in 307 with a secure connection. If, however, the profile does not have a user certificate, then in 306 the monitoring component may determine that no certificate based security is enabled on the network and the user may be authenticated without a certificate in 308, i.e., without a secure connection.

Operations 309-313 describe embodiments of the present invention. According to one embodiment, if in 301, the monitoring component determines that the user is not logged on to the system, then the monitoring module may retrieve the persistent profile list from the device in 309, and select and apply the appropriate persistent profile in 310. In 311, the monitoring module may then determine whether the persistent profile has a machine certificate associated with it. If it does, then in 312, the machine certificate may be used to authenticate the device to the network in 313, thus establishing a secure connection to the network. If, however, the persistent profile does not have a machine certificate, then the monitoring component may determine in 306 that no certificate based security is enabled on the network and the device may be authenticated without a certificate in 308 (i.e., without a secure connection).

Embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such current and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
identifying that a user has logged off a device coupled to a wireless network; applying to the device a persistent profile that matches the network;
examining the persistent profile to determine whether it is associated with a machine certificate;
retrieving the machine certificate if the persistent profile is associated with the machine certificate; and
establishing a secure connection from the device to the wireless network utilizing the machine certificate.

2. The method according to claim 1 wherein applying to the device the persistent profile that matches the network further comprises:
retrieving persistent profiles on the device;
evaluating the persistent profiles to determine whether one of the persistent profiles matches the network;
selecting the persistent profile that matches the network; and
applying the persistent profile.

3. The method according to claim 1 wherein identifying that the user has logged off the device further comprises receiving notification that the user has logged off the network.

4. The method according to claim 1 wherein establishing the secure connection from the device to the wireless network utilizing the machine certificate further comprises authenticating the device to the wireless network with the machine certificate.

5. The method according to claim 1 further comprising:
establishing an unsecure connection to the wireless network if the persistent profile is not associated with the machine certificate.

6. A method comprising:
applying a persistent profile to a device coupled to a wireless network when a user is not logged into the device;
examining the persistent profile to determine whether a machine certificate is associated with the persistent profile; and
utilizing the machine certificate to establish a secure connection to the wireless network if the machine certificate is associated with the persistent profile.

7. The method according to claim 6 wherein applying the persistent profile further comprises:
examining a list of persistent profiles on the device;
identifying the persistent profile from the list of persistent profiles, the persistent profile matching the wireless network; and
applying the persistent profile to the device.

8. The method according to claim 6 further comprising:
establishing an unsecure connection to the wireless network if the machine certificate is not associated with the persistent profile.

9. An article comprising a machine-accessible medium having stored thereon instructions that, when executed by a machine, cause the machine to:
identify that a user has logged off a device coupled to a wireless network;
applying to the device a persistent profile that matches the network;
examine the persistent profile to determine whether it is associated with a machine certificate;
retrieve the machine certificate if the persistent profile is associated with the machine certificate; and
establish a secure connection from the device to the wireless network utilizing the machine certificate.

10. The article according to claim 9 wherein the instructions, when executed by the machine, further cause the machine to apply to the device the persistent profile that matches the network by:
retrieving persistent profiles on the device;
evaluating the persistent profiles to determine whether one of the persistent profiles matches the network;
selecting the persistent profile that matches the network; and
applying the persistent profile.

11. The article according to claim 9 wherein the instructions, when executed by the machine, further cause the machine to identify that the user has logged off the device by receiving notification that the user has logged off the network.

12. The article according to claim 9 wherein the instructions, when executed by the machine, further cause the machine to establish the secure connection from the device to the wireless network utilizing the machine certificate by authenticating the device to the wireless network with the machine certificate.

13. The article according to claim 9 wherein the instructions, when executed by the machine, further cause the machine to establish an unsecure connection to the wireless network if the persistent profile is not associated with the machine certificate.

14. An article comprising a machine-accessible medium having stored thereon instructions that, when executed by a machine, cause the machine to:
apply a persistent profile to a device coupled to a wireless network when a user is not logged into the device;
examine the persistent profile to determine whether a machine certificate is associated with the persistent profile; and
utilize the machine certificate to establish a secure connection to the wireless network if a machine certificate is associated with the persistent profile.

15. The article according to claim 14 wherein the instructions, when executed by the machine, further cause the machine to apply the persistent profile by:
examining a list of persistent profiles on the device;
identifying the persistent profile from the list of persistent profiles, the persistent profile matching the wireless network; and
applying the persistent profile to the device.

16. The article according to claim 14 wherein the instructions, when executed by the machine, further cause the machine to establish an unsecure connection to the wireless network if the machine certificate is not associated with the persistent profile.

17. A system comprising:
a monitoring component capable of determining whether a user is logged on to a device coupled to a wireless network;
a machine certificate; and
a persistent profile, the monitoring component capable of selecting the persistent profile if the persistent profile matches the wireless network, the monitoring component additionally capable of applying the persistent profile to the device and examining the persistent profile to determine if the persistent profile is associated with a machine certificate.

18. The system according to claim 17 wherein the monitoring component is additionally capable of establishing a secure connection to the wireless network utilizing the machine certificate if the persistent profile is associated with a machine certificate.

19. The system according to claim 18 wherein the monitoring component is capable of establishing the secure connection to the wireless network by utilizing the machine certificate to authenticate the device to the wireless network.

20. The system according to claim 17 wherein the monitoring component is additionally capable of establishing an unsecure connection to the wireless network if the persistent profile is not associated with a machine certificate.
